(19) United States
(12) Patent Application Publication
(10) Pub. No.: US 2009/0267880 A1
(43) Pub. Date: Oct. 29, 2009

(54) LIQUID CRYSTAL DISPLAY DEVICE

(75) Inventors: Yoshito Hashimoto, Mie (JP); Masumi Kubo, Nara (JP); Takako Nakai, Nara (JP)

Correspondence Address: NIXON & VANDERHYE, PC, 901 NORTH GLEBE ROAD, 11TH FLOOR, ARLINGTON, VA, 22203, US

(73) Assignee: Sharp Kabushiki Kaisha, Osaka-shi, Osaka (JP)

(21) Appl. No.: 12/088,106

(22) PCT Filed: Sep. 25, 2006
(86) PCT No.: PCT/JP2006/318973

§ 371 Date: Jun. 16, 2009

(30) Foreign Application Priority Data
Sep. 28, 2005 (JP) 2005-281743

(51) Int. Cl. G09G 3/36; G02F 1/1337

(52) U.S. Cl. 345/89; 349/129

(57) ABSTRACT

A pixel has a first liquid crystal domain. In the first liquid crystal domain, first and second pretilt directions of liquid crystal molecules, defined by first and second alignment films, respectively, intersect with each other at substantially right angles. Also, in the first liquid crystal domain, when a signal voltage is applied to the liquid crystal layer to display the highest gray scale, liquid crystal molecules, located around the center of a plane of the liquid crystal layer and around the middle of the thickness of the liquid crystal layer, are tilted in a first direction that substantially equally divides the first and second pretilt directions into two. A driver applies a signal voltage to the liquid crystal layer of the pixel every vertical scanning period. At least while display gray scales are changing from the lowest gray scale into the highest one, the driver applies a voltage that is at least 0.96 times as high as the threshold voltage Vth of the liquid crystal layer in a vertical scanning period just before the signal voltage is applied to display the highest gray scale.

### TECHNICAL FIELD

The present invention relates to a liquid crystal display device and more particularly relates to a liquid crystal display device with a wide viewing angle characteristic.

### BACKGROUND ART

Recently, the display performances of liquid crystal displays (LCDs) have been improved to the point that more and more manufacturers adopt LCD panels as TV monitors, for example. As a result of those researches and developments, the viewing angle characteristic of LCDs has been improved to a certain degree but not satisfactorily in some respects. Among other things, there is still a high demand for improvement of the viewing angle characteristic of an LCD using a vertical alignment liquid crystal layer (which is sometimes called a “VA mode LCD”).

A VA mode LCD, which is currently used for a TV set with a big screen, for example, adopts a multi-domain structure (which is also called a “pixel division structure” and) in which multiple liquid crystal domains are formed in a single pixel region, to improve the viewing angle characteristic. An MVA mode is often adopted as a method of forming such a multi-domain structure. Specifically, according to the MVA mode, an alignment control structure is provided on one side of the two substrates, which face each other with a vertical alignment liquid crystal layer interposed between them, so as to face the liquid crystal layer, thereby forming multiple domains with mutually different alignment directions (i.e., tilt directions), the number of which is typically four. As the alignment control structure, a slit (as an opening) or a rib (as a projection structure) may be provided for an electrode, thereby creating an anchoring force from both sides of the liquid crystal layer.

If a slit or a rib is adopted, however, the anchoring force will be applied onto liquid crystal molecules non-uniformly within a pixel region because the slit or rib has a linear structure unlike the situation where the pretilt directions are defined by an alignment film in a conventional TN mode LCD. As a result, the response speed may have a distribution unintentionally. In addition, since the transmittance of light will decrease in the areas with the slits or ribs, the luminance on the screen will decrease, too.

To avoid these problems, the VA mode LCD also preferably has a multi-domain structure by defining a pretilt direction with an alignment film. Examples of other known methods for defining pretilt directions include a rubbing treatment and an optical alignment treatment. When a multi-domain structure is formed by a rubbing treatment, a resist pattern is used to define areas to rub and areas not to rub. On the other hand, if the optical alignment treatment is performed, multiple domains are created by performing an exposure process using a photomask several times.

As an exemplary VA mode LCD that controls the pretilt direction with an alignment film, proposed was a VA mode LCD in which liquid crystal molecules come to have a twisted structure by using two vertical alignment films that define pretilt directions intersecting with each other at right angles for the two substrates. Such an LCD is called either an RTN (reverse twisted nematic) mode LCD or a VATN (vertical alignment twisted nematic) mode LCD (see Patent Documents Nos. 1 to 4, for example). In the RTN mode, the pretilt directions of liquid crystal molecules that are defined by the two vertical alignment films are parallel to, or perpendicular to, the absorption axes of two polarizers that are arranged as crossed Nicols with the liquid crystal layer interposed between them. Also, in the RTN mode, when a sufficiently high voltage (which is at least equal to a signal voltage to display the highest gray scale) is applied to the liquid crystal layer, liquid crystal molecules, located around the center of a plane of the liquid crystal layer and around the middle of the thickness of the liquid crystal layer, are tilted in a direction that substantially equally divides the two pretilt directions defined by the alignment films into two. If four liquid crystal domains, in which those liquid crystal molecules, located around the center and middle of the liquid crystal layer, have mutually different tilt directions, are defined in each pixel (which structure will be referred to herein as a “four domain structure”), the RTN mode can reduce the total number of times the alignment treatment (which may be either rubbing treatment or optical alignment treatment) needs to be performed on the two alignment films to four in the best case scenario.
Patent Document No. 1: Japanese Patent Application Laid-Open Publication No. 11-352486
Patent Document No. 2: Japanese Patent Application Laid-Open Publication No. 2002-277877
Patent Document No. 3: Japanese Patent Application Laid-Open Publication No. 11-133429
Patent Document No. 4: Japanese Patent Application Laid-Open Publication No. 10-123576

### DISCLOSURE OF INVENTION

### Problems to be Solved by the Invention

However, while analyzing the display performance of an RTN-mode LCD, the present inventors discovered that the RTN mode had a unique problem in terms of response characteristic.

In order to overcome the problems described above, an object of the present invention is to improve the response characteristic of an RTN-mode liquid crystal display device.

### Means for Solving the Problems

A liquid crystal display device according to the present invention includes a liquid crystal panel and a driver. The liquid crystal panel includes: a vertical alignment liquid crystal layer having a liquid crystal material with negative dielectric anisotropy; first and second substrates that face each other with the liquid crystal layer interposed between them; a first electrode arranged on one surface of the first substrate so as to face the liquid crystal layer; a second electrode arranged on one surface of the second substrate so as to face the liquid crystal layer; a first alignment film arranged on one surface of the first electrode so as to face the liquid crystal layer; and a second alignment film arranged on one surface of the second electrode so as to face the liquid crystal layer. A pixel has a first liquid crystal domain. In the first liquid crystal domain, first and second pretilt directions of liquid crystal molecules, defined by the first and second alignment films, respectively, intersect with each other at substantially right angles. Also, in the first liquid crystal domain, when a signal voltage is applied to the liquid crystal layer to display the highest gray scale, liquid crystal molecules, located around the center of a plane of the liquid crystal layer and around the middle of the thickness of the liquid crystal layer, are tilted in a first direction that substantially equally divides the first and second pretilt directions into two. The driver applies a signal voltage to the liquid crystal layer of the pixel every vertical scanning period. At least while display gray scales are changing from the lowest gray scale into the highest one, the driver applies a voltage that is at least 0.96 times as high as the threshold voltage Vth of the liquid crystal layer in a vertical scanning period just before the signal voltage is applied to display the highest gray scale.

In one preferred embodiment, a signal voltage to display the lowest gray scale is less than 0.96 times as high as the threshold voltage Vth.

In another preferred embodiment, while display gray scales are changing from the lowest gray scale into one for applying a signal voltage that is 2.2 or more times as high as the threshold voltage Vth, the driver applies a voltage that is at least 0.96 times as high as the threshold voltage Vth of the liquid crystal layer in a vertical scanning period just before the signal voltage is applied.

In still another preferred embodiment, every time display gray scales change from the lowest gray scale into another one, a voltage that is at least 0.96 times as high as the threshold voltage Vth of the liquid crystal layer is applied in a vertical scanning period just before the signal voltage is applied.

In yet another preferred embodiment, the driver is able to apply an overshoot voltage as the signal voltage.

In yet another preferred embodiment, the pixel further has second, third and fourth liquid crystal domains where when a signal voltage is applied to the liquid crystal layer to display the highest gray scale, liquid crystal molecules, located around the center of a plane of the liquid crystal layer and around the middle of the thickness of the liquid crystal layer, are tilted in second, third and fourth directions, respectively. The first, second, third and fourth directions are four directions, any two of which have a difference that is substantially equal to an integral multiple of 90 degrees.

In yet another preferred embodiment, the pixel has a number of subpixels, of which the respective liquid crystal layers are supplied with mutually different signal voltages. At least while display gray scales are changing from the lowest gray scale into the highest one, the driver applies a voltage, which is at least 0.96 times as high as the threshold voltage Vth of the liquid crystal layer, to the liquid crystal layer of at least one of those subpixels in a vertical scanning period just before the signal voltage is applied to display the highest gray scale.

### EFFECTS OF THE INVENTION

According to the present invention, the display quality of an RTN mode LCD can be improved in terms of response speed, among other things. Optionally, if the method of the present invention is combined with an overshoot drive, the ability of the LCD to present a moving picture can be improved. Furthermore, if the present invention is combined with the multi-domain and/or pixel division technique(s), the viewing angle characteristic of the LCD can also be improved.

### BRIEF DESCRIPTION OF DRAWINGS

FIG. 1 is a graph showing how the transmittance of an RTN-mode LCD changes with time in a situation where a voltage that is three times as high as a threshold voltage Vth is applied to a liquid crystal layer that has been supplied with no voltage.

FIG. 2(a) is a CG image simulating the orientation state of a liquid crystal molecule to which no voltage is applied yet (in 0 ms after the application of the voltage), while FIGS. 2(b), 2(c), 2(d) and 2(e) are CG images simulating the orientation states of the liquid crystal molecule in 2 ms, 10 ms, 25 ms and 50 ms, respectively, after a voltage that is three times as high as the threshold voltage Vth has been applied thereto.

FIG. 3 is a graph showing the tilt directions of the liquid crystal molecule shown in FIG. 2 that are plotted as a function of the point in the thickness direction.

FIG. 4 shows graphs showing how the transmittance changes with time if the applied voltage is 1.75, 2, 2.25, 2.5, 2.75 or 3 times as high as the threshold voltage Vth. Specifically, the results shown in FIGS. 4(a) and 4(b) were obtained when liquid crystal material A was used and when liquid crystal material B was used, respectively.

FIG. 5 is a graph representing the response characteristic (or variation in transmittance with time) shown in FIG. 4 in a different form, of which the abscissa represents the saturated voltage and the ordinate represents the rise time Tr (0-90%).

FIG. 6 shows graphs showing the response characteristic (or variation in transmittance with time) of an RTN mode LCD. Specifically, FIGS. 6(a), 6(b) and 6(c) are graphs showing the influences of the pretilt angle, the cell thickness, and the viscosity γ1 of the liquid crystal material, respectively.

FIG. 7 is a graph showing how the transmittance of an RTN-mode LCD changes with time in a situation where a voltage that is three times as high as the threshold voltage Vth is applied to a liquid crystal layer that has been supplied with a voltage (i.e., a start voltage).

FIG. 8(a) is a graph representing the response characteristic (or the variation in transmittance with time) shown in FIG. 7 in a different form, of which the abscissa represents the start voltage and the ordinate represents the rise time Tr (0-90%), while FIGS. 8(b), 8(c) and 8(d) are graphs showing the results of the situations where the pretilt angle was 88 degrees, 87 degrees and 86 degrees, respectively.

FIGS. 9(a), 9(b) and 9(c) are graphs showing the influences of the cell thickness, the viscosity of the liquid crystal material, and the combination of cell thickness and type of the liquid crystal material on the start voltage dependence of the rise time Tr (0-90%).

FIG. 10 shows graphs showing the start voltage dependence of the rise time Tr (0-90%) of a VA-mode LCD. Specifically, FIG. 10(a) shows the influence of the pretilt angle, while FIG. 10(b) shows the influence of the cell thickness.

FIG. 11 shows the waveforms of signal voltages in an LCD according to the present invention.

FIG. 12(a) shows how the transmittance changes with time in a conventional VA-mode LCD, while FIG. 12(b) shows how the transmittance changes with time in an RTN-mode LCD according to the present invention.

### BEST MODE FOR CARRYING OUT THE INVENTION

Hereinafter, a configuration for a liquid crystal display device according to a preferred embodiment of the present invention will be described with reference to the accompanying drawings. However, the present invention is in no way limited to the specific preferred embodiments to be described below.

A liquid crystal display device according to a preferred embodiment of the present invention is an RTN mode LCD including a vertical alignment liquid crystal layer having a liquid crystal material with negative dielectric anisotropy. The LCD includes a driver for applying a signal voltage to the liquid crystal layer of each pixel every vertical scanning period. The LCD is characterized in that at least while display gray scales are changing from the lowest gray scale into the highest one, the driver applies a voltage that is at least 0.96 times as high as the threshold voltage Vth of the liquid crystal layer in a vertical scanning period just before the signal voltage is applied to display the highest gray scale. By taking advantage of this feature, it is possible to prevent the RTN mode LCD from exhibiting its unique poor response characteristic, which was detected by the present inventors.

As used herein, the “vertical alignment liquid crystal layer” refers to a liquid crystal layer in which the axis of liquid crystal molecules (which will be sometimes referred to herein as an “axial direction”) defines an angle of approximately 85 degrees or more with respect to the surface of a vertical alignment film. The liquid crystal molecules have negative dielectric anisotropy and are combined with polarizers that are arranged as crossed Nicols to conduct a display operation in a normally black mode. In view of the viewing angle characteristic, a multi-domain structure (e.g., a four domain structure, among other things) is preferably adopted as described above. However, an object of the present invention is to resolve a common problem for various RTN-mode LCDs (i.e., the problem to arise in each domain when the multi-domain structure is adopted). That is why an RTN-mode LCD with a simple pixel structure, not the multi-domain structure, will be described.

Also, as used herein, the “pixel” refers to the smallest unit to represent a particular gray scale in a display operation. In conducting a color display operation, the “pixels” are equivalent to units representing R, G and B gray scales, respectively, and are also called “dots”. A combination of the R, G and B pixels forms a single color display pixel. Also, a “pixel” refers herein to a region of the LCD allocated to the “pixel” for display. The “pretilt direction”⁷ means herein the alignment direction of liquid crystal molecules that is controlled with an alignment film and refers herein to the azimuthal direction on a display plane. For the sake of simplicity, the pretilt direction will be sometimes referred to herein as the “pretilt direction of a vertical alignment film”. Also, the angle defined by the liquid crystal molecules with respect to the surface of the alignment film in such a situation will be referred to herein as a “pretilt angle”. The pretilt direction is defined by subjecting the alignment film to either a rubbing treatment or an optical alignment treatment. By changing the combinations of pretilt directions of two alignment films that face each other with the liquid crystal layer interposed between them, a four domain structure can be formed. Such a pixel that has been divided into four has four liquid crystal domains (which will be sometimes referred to herein as “domains” simply). Each of those liquid crystal domains is characterized by the tilt direction of liquid crystal molecules that are located around the center of a plane and around the middle of the thickness of the liquid crystal layer, to which a sufficiently high voltage is applied. That tilt direction will be sometimes referred to herein as a “reference alignment direction”. And this tilt direction (or reference alignment direction) determines the viewing angle dependence of each domain. The tilt direction is also an azimuthal direction. The reference of the azimuthal direction is supposed to be the horizontal direction on the screen and the azimuthal direction is supposed to increase counterclockwise in the positive domain. Comparing the display screen to the face of a clock, for example, the three o'clock direction is supposed to have an azimuthal angle of zero degrees and the azimuthal angle is supposed to increase counterclockwise. If the tilt directions of the four liquid crystal domains are defined to be four directions, any two of which have a difference that is substantially equal to an integral multiple of 90 degrees (e.g., twelve o'clock, nine o'clock, six o'clock and 3 o'clock directions), the viewing angle characteristic can be averaged and a good image can be presented. To achieve as uniform viewing angle characteristic as possible, the respective areas of the four liquid crystal domains in each pixel are preferably equal to each other.

In the preferred embodiment to be described below, the vertical alignment liquid crystal layer has a nematic liquid crystal material with negative dielectric anisotropy. The pretilt direction defined by one of the two alignment films that are arranged on both sides of the liquid crystal layer is different from the one defined by the other alignment film by 90 degrees. And the tilt angle (i.e., the reference alignment direction) is defined to be the intermediate direction between these two pretilt directions. No chiral agent is added to the liquid crystal layer. That is why when a voltage is applied to the liquid crystal layer, the liquid crystal molecules near the alignment film come to have a twisted alignment pattern under the anchoring force of the alignment film. If necessary, however, a chiral agent may be added to the liquid crystal layer. By using such a pair of vertical alignment films that defines pretilt directions (i.e., alignment treatment directions) intersecting with each other at right angles, an RTN mode in which the liquid crystal molecules have a twisted alignment pattern is realized.

In the RTN mode, the pretilt angles defined by the two alignment films are preferably substantially equal to each other as disclosed by the applicant of the present application in Japanese Patent Application No. 2005-141846. By using such alignment films that have substantially equal pretilt angles, the display luminance characteristic can be improved. In particular, if the difference between the pretilt angles defined by the two alignment films is less than one degree, then the tilt directions of liquid crystal molecules located around the center of the liquid crystal layer (i.e., the reference alignment direction) can be controlled with stability. As a result, the display luminance characteristic can be improved. This should be because if the difference between the pretilt angles exceeded one degree, the tilt directions would vary from one location of the liquid crystal layer to another and the transmittance would also vary as a result. That is to say, some regions would have lower transmittance than the desired one.

Examples of known methods for getting the pretilt directions of liquid crystal molecules defined by alignment films include a process that requires a rubbing treatment, a process that requires an optical alignment treatment, a process in which a fine structure is formed in advance under each alignment film such that the surface pattern of the fine structure is reflected on the surface of the alignment film, and a process in which an alignment film with a fine surface pattern is formed by obliquely depositing an inorganic substance such as SiO. Considering their mass productivity, however, the process requiring the rubbing treatment or the optical alignment treatment is preferred. Among other things, the optical alignment treatment can be done without making any physical contact. That is why unlike the rubbing treatment, the optical alignment treatment would produce no static electricity and could increase the yield. Furthermore, as disclosed in Japanese Patent Application No. 2005-141846, by using an optical alignment film including a photosensitive group that can form a bond structure, the variation in the pretilt angle can be reduced to one degree or less. Specifically, the alignment film preferably includes at least one photosensitive group selected from the group consisting of 4-carcone group, 4′-carcone group, coumarin group and cinnamoyl group.

Hereinafter, the problem unique to the RTN mode, which was spotted by the present inventors, will be described. The following analysis was based on the results of simulations we carried out with LCD MASER produced by Shintech, Inc. As for some of those results of simulations, we confirmed their reliability through experiments.

Parameters of a liquid crystal cell that was used for the simulations are shown in the following Table 1. The liquid crystal layer was supposed to have a retardation of 320 nm, no matter whether liquid crystal material A or B was used. With the liquid crystal material A, the liquid crystal layer had a thickness of 3.9 μm. On the other hand, with the liquid crystal material B, the liquid crystal layer had a thickness of 3.4 μm.

TABLE 1

| Type of material | Liquid crystal | Liquid crystal |
|---|---|---|
| used | material A | material B |
| Δ ε | −4.1 | −3.1 |
| K₁₁ (pN) | 15.9 | 14.2 |
| K₃₃ (pN) | 18.4 | 15.2 |
| γ 1 (mPa · s) | 163 | 127 |
| Vth (V) | 2.24 | 2.34 |

The threshold voltage Vth=π×{K₃₃/(ε₀×|Δ|ε|)}^{1/2} where ε₀ is the dielectric constant of vacuum and Δε is relative dielectric anisotropy (at 1 kHz, for example).

As just shown under Table 1, the threshold voltage Vth of the RTN-mode LCD used here is a voltage determined by the physical property values (i.e., the dielectric constant and elastic constant) of a liquid crystal material and does not depend on the optical arrangement, unlike the threshold voltage of a so-called “V-T characteristic”. Unless otherwise stated, the threshold voltage of a liquid crystal layer is defined herein as such. Also, in the voltage-transmittance characteristic of an RTN-mode LCD, the amplitude of the voltage applied to the liquid crystal layer is supposed to be normalized with the threshold voltage.

Problem with the Response Characteristic of RTN-Mode LCD

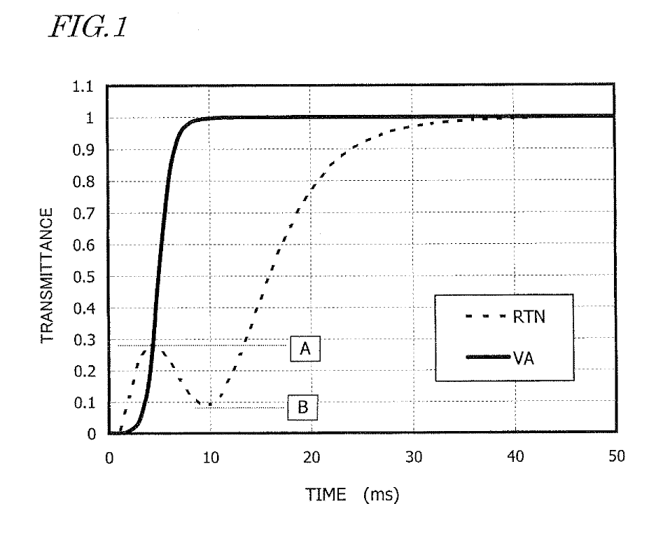

Hereinafter, it will be described with reference to FIGS. 1 through 3 exactly what is the problem with the response characteristic of an RTN-mode LCD.

FIG. 1 is a graph showing how the transmittance of an RTN-mode LCD changes with time in a situation where a voltage that is three times as high as the threshold voltage Vth (and that is substantially equal to the voltage applied at the highest gray scale) is applied to the liquid crystal layer that has been supplied with no voltage. For the purpose of comparison, FIG. 1 also shows a curve showing how the transmittance changes with time if only the modes are changed into VA mode without changing the pretilt angle, voltage conditions and other parameters. In FIG. 1, the ordinate represents a value normalized with a saturated transmittance (i.e., a transmittance value that no longer changes with time once reached).

As shown in FIG. 1, in the RTN-mode LCD, the transmittance does not increase monotonically to a value associated with the applied voltage unlike the VA-mode LCD, but increases to point A, decreases to point B once, and then increases to the value associated with the applied voltage. Also, it takes a longer time for the RTN-mode LCD to reach that transmittance value associated with the applied voltage (i.e., a target transmittance, or the gray scale to display) than in the VA-mode LCD. Specifically, the VA-mode LCD reached the target transmittance in approximately 10 ms, whereas it took as long as about 40 ms for the RTN-mode LCD to reach it. A typical LCD has one vertical scanning period of 16.7 ms (which corresponds to a half frame of an NTSC interlaced signal). Thus, it can be seen that the response speed of the RTN-mode LCD is not sufficiently high. Unless stated otherwise, the “one vertical scanning period” refers to a period defined for an LCD, not a period defined with an input video signal, and means an interval between a point in time a signal voltage is applied to one pixel and a point in time another signal voltage is applied to the same pixel. For example, an NTSC signal has one frame period of 33.3 ms. In a normal LCD, however, a signal voltage is supposed to be written on every pixel within a half frame period of the NTSC signal (i.e., within one field period of 16.7 ms). That is why one vertical scanning period of an LCD is 16.7 ms. Furthermore, if an LCD needs to be driven at double the rate in order to improve the response characteristic, for example, the LCD will have one vertical scanning period thereof further halved to 8.4 ms. It should be noted that the signal voltage applied to every pixel is not limited to the voltage associated with the gray scale to display (i.e., gray scale voltage) but also includes an overshoot voltage to improve the response characteristic, a black display voltage for pseudo-impulse drive (i.e., black insert drive), and any other voltage applied to a pixel.

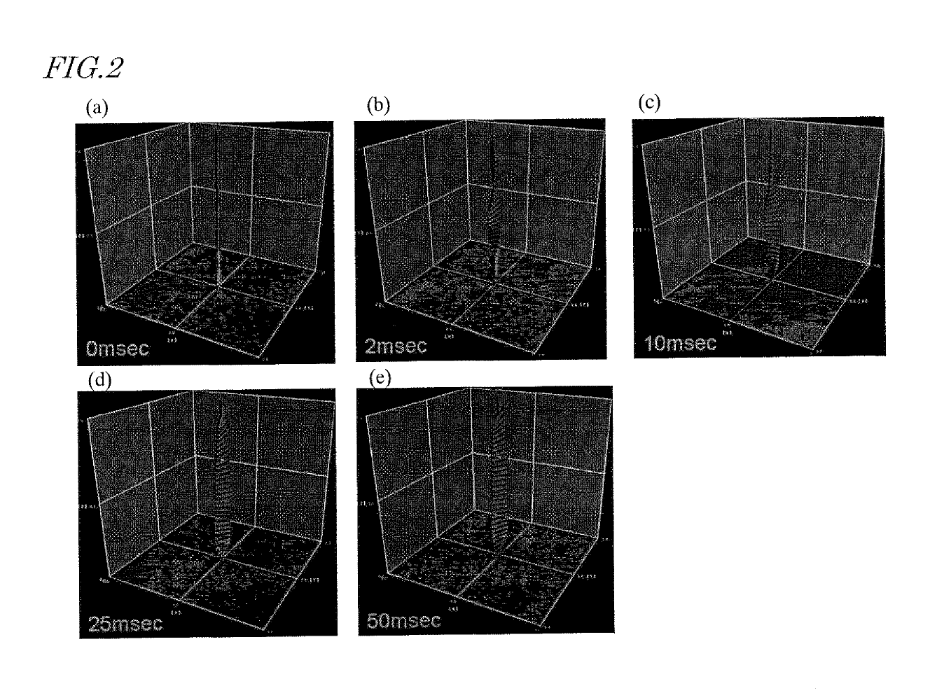

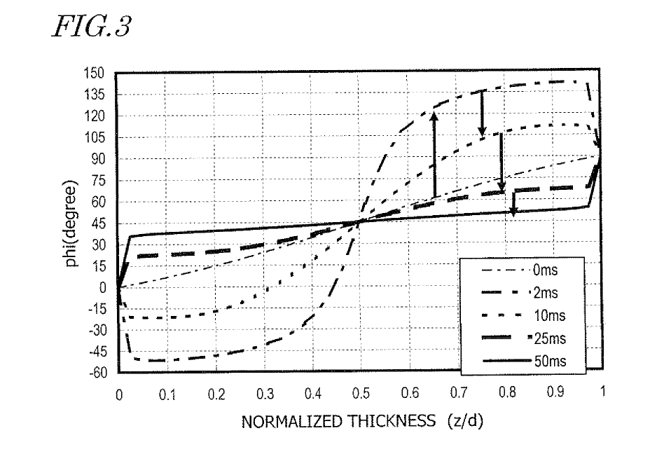

Next, it will be described with reference to FIGS. 2(a) through 2(e) and FIG. 3 how liquid crystal molecules change their orientation states in the liquid crystal layer of the RTN-mode LCD shown in FIG. 1.

FIG. 2(a) is a CG image simulating the orientation state of a liquid crystal molecule to which no voltage is applied yet (which state will be sometimes referred to herein as “in 0 ms after the application of the voltage”). On the other hand, FIGS. 2(b), 2(c), 2(d) and 2(e) are CG images simulating the orientation states of the liquid crystal molecule in 2 ms, 10 ms, 25 ms and 50 ms, respectively, after a voltage that is three times as high as the threshold voltage Vth has been applied thereto. In FIG. 2, the two directions indicated by the cross at the bottom correspond to the absorption axis (or transmission axis) directions of two polarizers.

FIG. 3 is a graph showing the tilt directions of the liquid crystal molecule shown in FIG. 2 (with an azimuthal angle phi) that are plotted as a function of the point in the thickness direction. Specifically, FIG. 3 shows the distributions of the tilt angles of the liquid crystal molecules in 0 ms (i.e., no voltage applied), 2 ms, 10 ms, 25 ms and 50 ms after the application of the voltage, which correspond to FIGS. 2(a) through 2(e), respectively. In FIG. 3, the point in the thickness direction (z coordinate) is shown as a z/d ratio normalized with the thickness d of the liquid crystal layer. That is to say, z/d=0 indicates a point on the lower alignment film, z/d=1 indicates a point on the upper alignment film, and z/d=0.5 indicates a middle point in the thickness direction.

As can be seen from FIG. 3, when no voltage is applied (i.e., 0 ms), the tilt direction (i.e., the pretilt direction) of the liquid crystal molecule on the lower alignment film (where z/d=0) has an azimuthal angle of 0 degrees (corresponding to the three o'clock direction on a clock face). The tilt direction (i.e., the pretilt direction) of the liquid crystal molecule on the upper alignment film (where z/d=1) has an azimuthal angle of 90 degrees (corresponding to the twelve o'clock direction on a clock face). And the tilt direction of the liquid crystal molecule located at the middle of the thickness (where z/d=0.5) is defined by equally dividing the pretilt directions of the liquid crystal molecules on the upper and lower alignment films into two and has an azimuthal angle of 45 degrees. Also, the tilt directions change at a substantially constant rate in the thickness direction. That is to say, the line showing the results at 0 ms in FIG. 3 is almost linear.

On the other hand, in 50 ms after the application of the voltage, almost all liquid crystal molecules have a tilt direction defined by an azimuthal angle of 45 degrees except the liquid crystal molecules anchored to the upper and lower alignment films.

Also, as for the tilt directions of the liquid crystal molecules at the other points in time between 0 ms and 50 ms, it can be seen that those tilt directions do not change directly from the one in 0 ms into the one in 50 ms but once turn to the opposite direction (as indicated by the arrow in FIG. 3). As can be seen, since the liquid crystal molecules once change their tilt directions into the opposite direction after the application of a voltage and then recover stabilized tilt directions, two inflection points (i.e., a crest and a trough) appear in the variation of the transmittance with time as shown in FIG. 1.

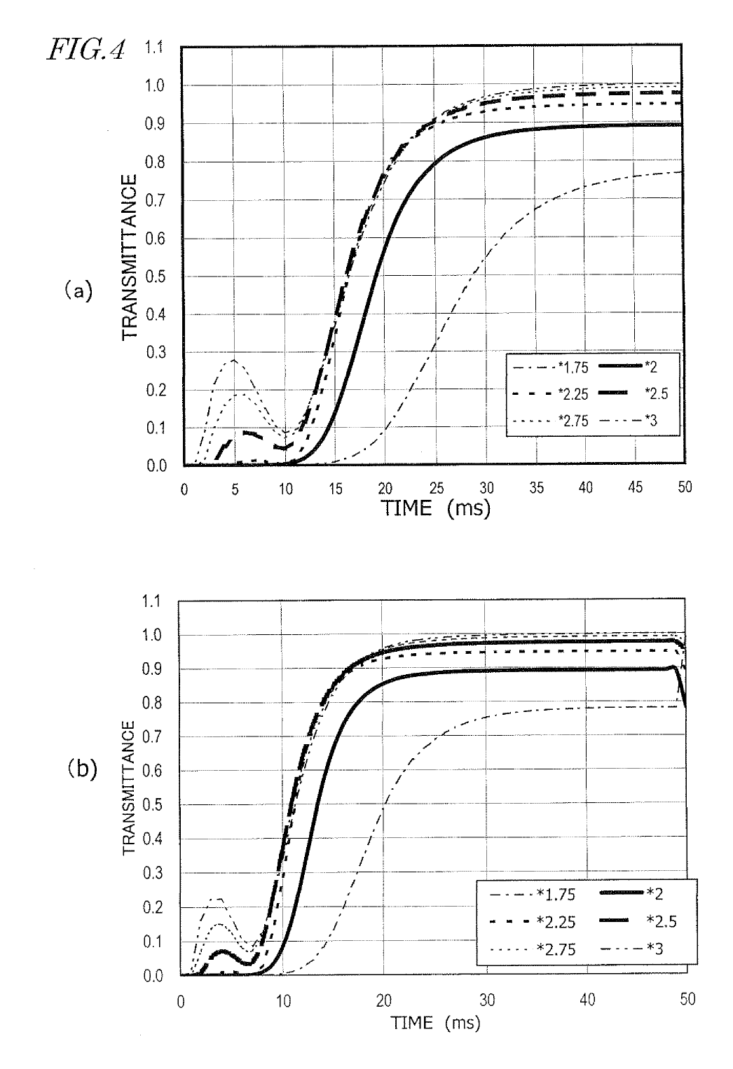

Next, the voltage dependence of the unique unusual response of the RTN mode will be described with reference to FIGS. 4(a) and 4(b), which are graphs showing how the transmittance change with time if the applied voltage is 1.75, 2, 2.25, 2.5, 2.75 or 3 times as high as the threshold voltage Vth. Specifically, the results shown in FIGS. 4(a) and 4(b) were obtained when the liquid crystal material A was used and when the liquid crystal material B was used, respectively.

As can be seen from FIG. 4, if the applied voltage becomes more than approximately twice as high as the threshold voltage Vth, the abnormal response unique to the RTN mode manifests itself. The magnitude of this applied voltage at which that abnormal response arises does not depend on the type of the liquid crystal material used.

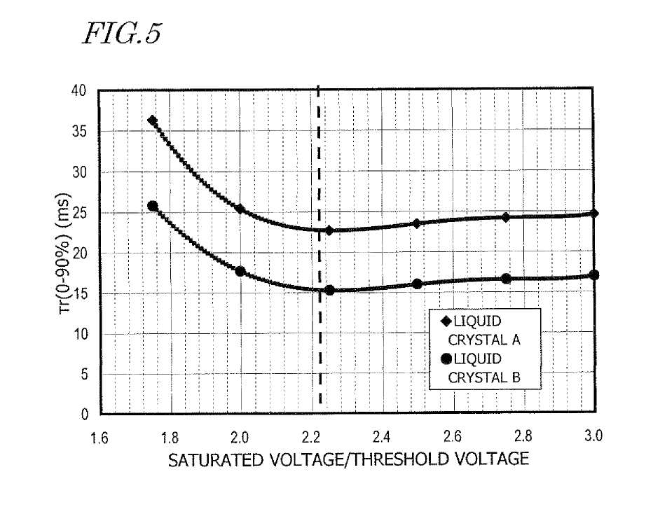

FIG. 5 is a graph representing the response characteristic (or variation in transmittance with time) shown in FIG. 4 in a different form, of which the abscissa represents the saturated voltage and the ordinate represents the rise time Tr (0-90%). As used herein, the “saturated voltage” refers to a voltage applied to a liquid crystal layer that has been supplied with no voltage yet, and Tr (0-90%) represents the amount of time it takes for the transmittance to reach 90% if the saturated voltage associated with the applied voltage is supposed to be 100%.

As can be seen from FIG. 5, as the saturated voltage increases, Tr (0-90%) decreases once. But when the saturated voltage becomes more than 2.2 times as high as the threshold voltage Vth, Tr (0-90%) starts to increase. This tendency was exhibited by both of the two liquid crystal materials A and B, and therefore, does not depend on the type of the liquid crystal material used. The reason why Tr (0-90%) starts to increase when the saturated voltage becomes more than 2.2 times as high as the threshold voltage Vth is the occurrence of the abnormal response described above.

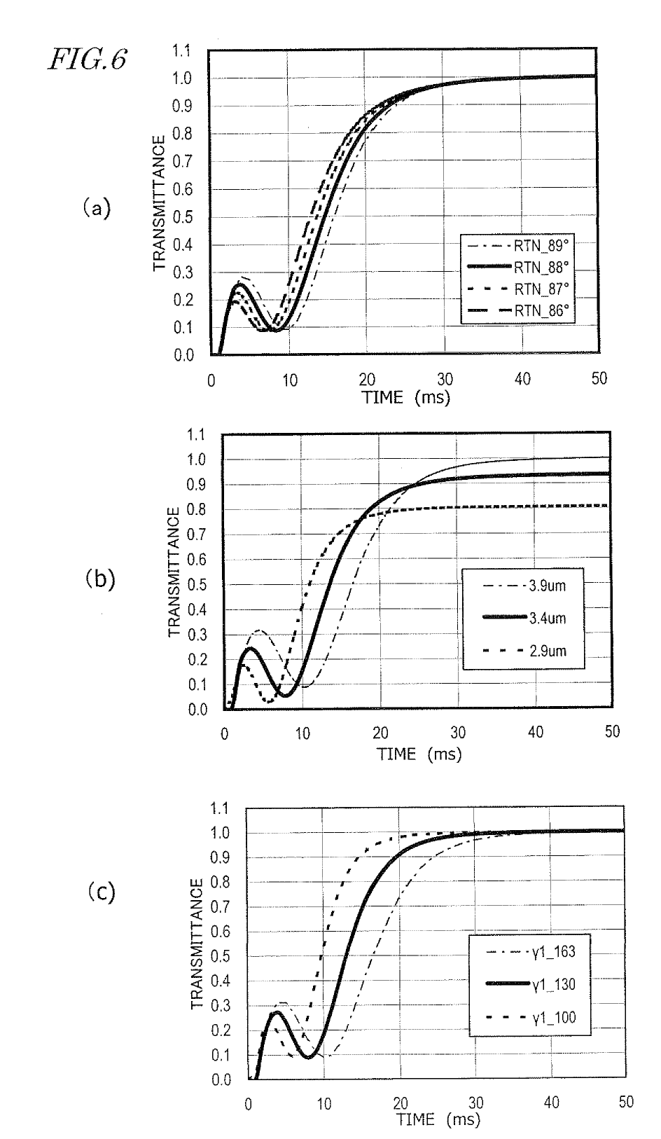

The present inventors analyzed the influence of cell parameters on that abnormal response unique to the RTN mode. The results of our analysis are shown in FIGS. 6(a) through 6(c). In this case, the liquid crystal material A was used. Specifically, FIGS. 6(a), 6(b) and 6(c) are graphs showing the influences of the pretilt angle, the cell thickness (i.e., the thickness of the liquid crystal layer), and the viscosity γ1 of the liquid crystal material, respectively.

As can be seen from FIG. 6(a), as the pretilt angle defined by the vertical alignment film decreased in the order of 89 degrees, 88 degrees, 87 degrees and then 86 degrees, the inflection point of the curve representing a variation in transmittance with time shifted toward a low-voltage range. But still the inflection point (or the crest and trough) remains. The pretilt angle should not be smaller than 85 degrees because the black display quality would decline at a pretilt angle of less than 85 degrees.

Also, as can be seen from FIG. 6(b), even if the thickness of the liquid crystal layer was reduced, the inflection point (i.e., the crest and tough) of the variation in transmittance with time just shifted toward a low-voltage range and still remained there.

Likewise, as can be seen from FIG. 6(c), even if the viscosity γ1 of the liquid crystal material was reduced in the order of 163 mPa·s, 130 mPa·s and then 100 mPa·s, the inflection point (i.e., the crest and tough) of the variation in transmittance with time just shifted toward a low-voltage range and still remained there.

As is clear from these results, even if the pretilt angle, the thickness of the liquid crystal cell or the viscosity of the liquid crystal material is optimized, it is still impossible to prevent the abnormal response unique to the RTN mode from manifesting itself.

As mentioned above, the present inventors discovered that such abnormal response occurred when a voltage that was 2.2 or more times as high as the threshold voltage was applied to the liquid crystal layer that had not been supplied with a voltage yet. Thus, the present inventors further carried out experiments to know what if such a voltage that was 2.2 or more times as high as the threshold voltage was applied to the liquid crystal layer that had been supplied with some voltage, not absolutely no voltage at all.

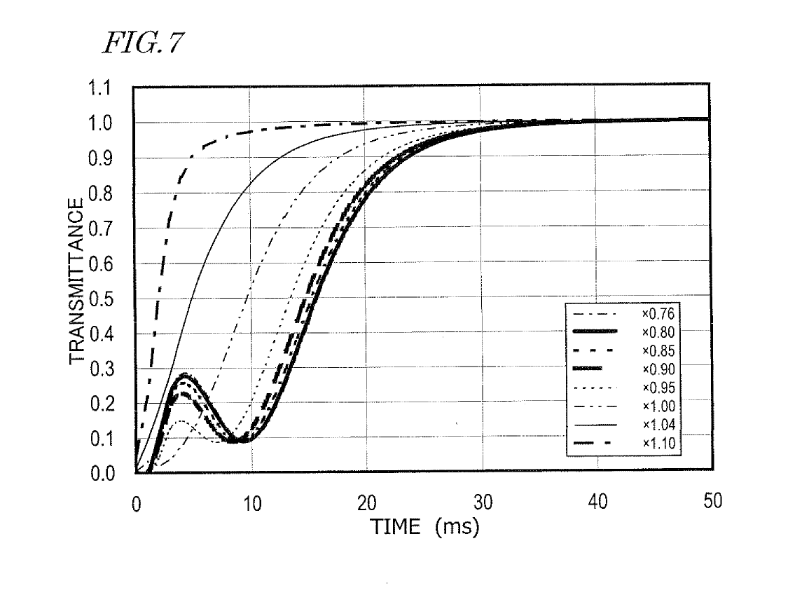

With the liquid crystal material A used, the pretilt angle set to be 89 degrees and the magnitudes of the voltage (which will be referred to herein as a “start voltage”) applied to the liquid crystal layer before a voltage that was three times as high as the threshold voltage Vth was applied thereto changed, the variations in transmittance with time were monitored. The results are shown in FIG. 7, which is a graph identical with FIG. 1 (in which the start voltage is 0 V) except that the start voltages were changed.

As can be seen easily from FIG. 7, as the start voltage was increased from a voltage that was 0.76 times as high as the threshold voltage Vth, the inflection point shifted toward a low-voltage range. Meanwhile, the height of the crest and the depth of the trough decreased gradually. And when the start voltage was 1.00 time as high as the threshold voltage Vth, no crest or trough was seen anymore.

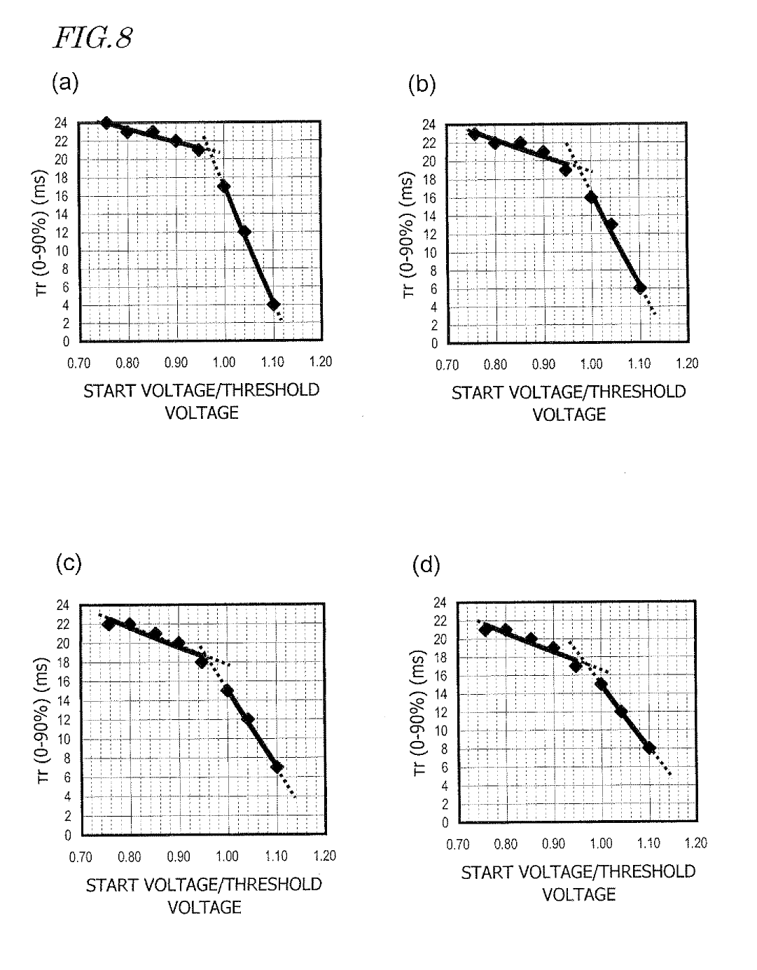

FIG. 8(a) is a graph representing the response characteristic (or the variation in transmittance with time) shown in FIG. 7 in a different form, of which the abscissa represents the start voltage and the ordinate represents the rise time Tr (0-90%). The results of the situations where the pretilt angle was 88 degrees, 87 degrees and 86 degrees, respectively, are shown in FIGS. 8(b), 8(c) and 8(d), respectively.

As can be seen from FIGS. 8(a) through 8(d), the rise time Tr (0-90%) is represented by two lines with mutually different gradients, which change at a voltage that is 0.96 times as high as the threshold voltage Vth. If the start voltage is less than 0.96 times as high as the threshold voltage Vth, the rise time is long and the voltage dependence is light (i.e., the gradient has a small absolute value). On the other hand, if the start voltage is 0.96 or more times as high as the threshold voltage Vth, the rise time is short and the voltage dependence is heavy (i.e., the gradient has a large absolute value). The rise time is long because the abnormal response described above is observed in the variation in transmittance with time if the start voltage is less than 0.96 times as high as the threshold voltage Vth. It should be noted that the point at which the start voltage dependence (or gradients) of the rise time changes (at the voltage that is 0.96 times as high as the threshold voltage Vth) is substantially constant if the pretilt angle falls within the range of 86 degrees to 89 degrees.

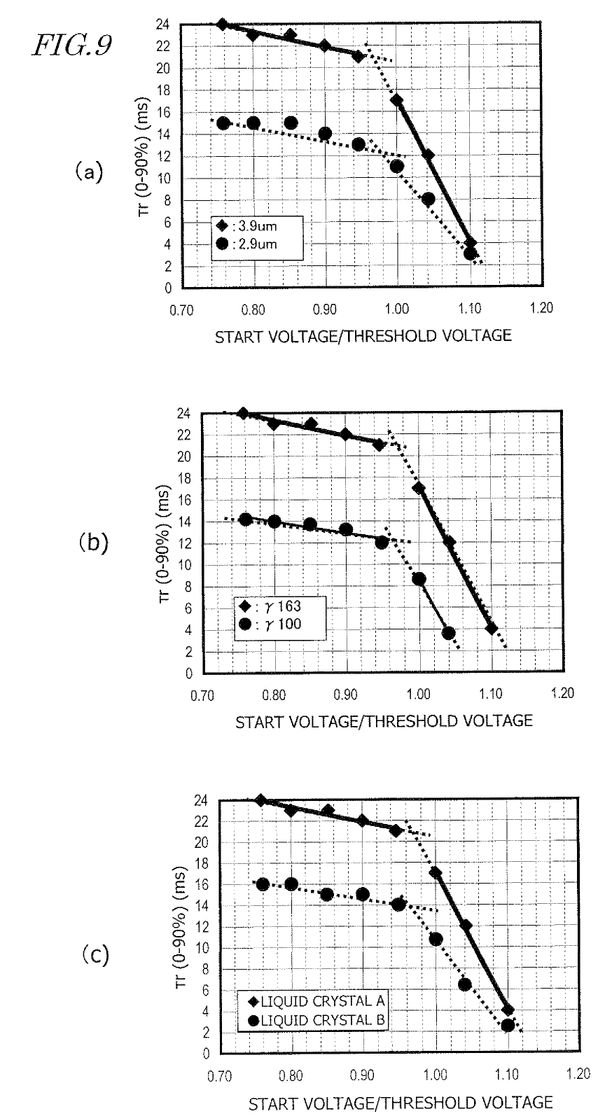

The present inventors also analyzed the influences of the cell thickness (that was 3.9 μm and 2.9 μm), the viscosity γ1 of the liquid crystal material (that was 163 mPa·s and 100 mPa·s), and the combination of cell thickness and type of the liquid crystal material (that was liquid crystal material A and a cell thickness of 3.9 μm and liquid crystal material B and a cell thickness of 3.4 μm). The results are shown in FIGS. 9(a) through 9(c). The pretilt angle was 89 degrees in each of these cases. As can be seen from the graphs showing the start voltage dependence of the rise time Tr (0-90%) in FIGS. 9(a) through 9(c), the point at which the start voltage dependence changed its gradients was a voltage that was approximately 0.96 times as high as the threshold voltage Vth.

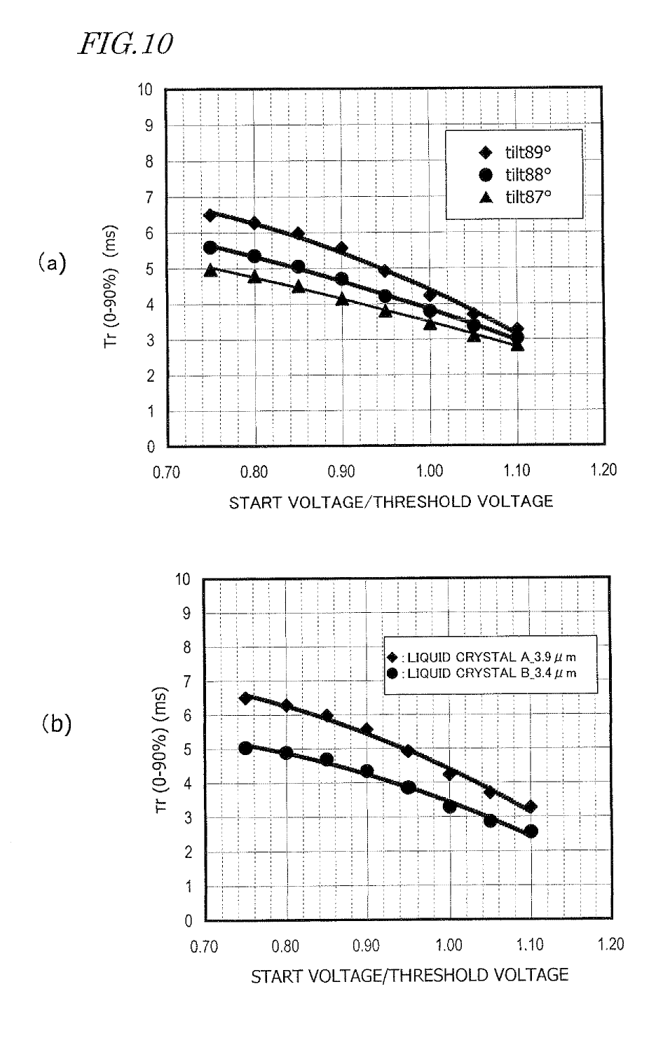

The present inventors carried out similar simulations on a VA-mode LCD, too. The results are shown in FIGS. 10(a) and 10(b) just for reference. Specifically, FIG. 10(a) shows the results of three situations where the pretilt angle was 87 degrees, 88 degrees and 89 degrees, respectively. On the other hand, FIG. 10(b) shows the results of two situations where the cell thickness was 3.9 μm and 3.4 μm, respectively, but where the pretilt angle was fixed at 89 degrees. As can be seen from FIG. 10, in the VA mode, the start voltage dependence (or gradient) of the rise time Tr (0-90%) was substantially constant and no discontinuity point was detected.

As is clear from the foregoing description, the abnormal response unique to the RTN mode occurs when a voltage that is at least 2.2 times as high as the threshold voltage Vth is applied in the black display state. And the higher the applied voltage (or the saturated voltage), the more noticeable the abnormal response gets. That is why in a liquid crystal display device in which the driver applies a signal voltage to a pixel every vertical scanning period, the abnormal response arises most noticeably when the display gray scales change from the lowest gray scale (corresponding to the black display state) into the highest one (corresponding to the white display state). Therefore, to avoid such abnormal response, at least when the display gray scales change from the lowest gray scale into the highest one, a voltage that is at least 0.96 times as high as the threshold voltage Vth of the liquid crystal layer needs to be applied in a vertical scanning period that is just before a signal voltage to display the highest gray scale is applied.

Naturally, the signal voltage to display the lowest gray scale may also be at least 0.96 times as high as the threshold voltage Vth. In the vicinity of the threshold voltage Vth, however, the liquid crystal molecules start to fall under the influence of the electric field and there is a concern about a possible increase in transmittance (i.e., concern about excessive luminance for the black display state). In fact, in products currently available, the signal voltage to display the lowest gray scale is approximately 0.3 times as high as the threshold voltage Vth. For that reason, the signal voltage to display the lowest gray scale is preferably less than 0.96 times as high as the threshold voltage Vth. And only in a vertical scanning period just before the abnormal response occurs as a result of a gray scale transition, a voltage that is at least 0.96 times as high as the threshold voltage Vth is preferably applied.

In this case, the gray scale transition that produces the abnormal response does not necessarily mean a situation where the voltage (i.e., gray scale voltage) associated with the gray scale to display after the transition is 2.2 or more times as high as the threshold voltage Vth. Even if the gray scale voltage after the transition is less than 2.2 times as high as the threshold voltage Vth, an overshoot voltage (OS voltage) higher than the gray scale voltage may need to be applied to increase the response speed. In that case, if the OS voltage is 2.2 or more times as high as the threshold voltage Vth, the abnormal response still manifests itself. Thus, even in that case, a voltage that is at least 0.96 times as high as the threshold voltage Vth is preferably applied in that previous vertical scanning period. The overshoot drive method disclosed in Japanese Patent Application Laid-Open Publication No. 2003-172915 may be adopted, for example. However, this is just an example and any other known overshoot drive method may also be adopted as well.

As will be described later, the improvement of the response characteristic to be achieved by applying a voltage that is at least 0.96 times as high as the threshold voltage Vth is accomplished not just when the gray scale voltage associated with the gray scale to display after the transition from the black display state or the OS voltage is 2.2 or more times as high as the threshold voltage Vth. Optionally, before making a transition from the lowest gray scale into every other gray scale, the voltage that is at least 0.96 times as high as the threshold voltage Vth may be applied.

Hereinafter, the present invention will be described by way of specific examples. The parameters of the liquid crystal cell used in a specific example of the present invention included the liquid crystal material A (with a threshold voltage Vth of 2.24 V), a cell thickness of 3.9 μm, and a pretilt angle of 89 degrees. In the following example, it will be described how to make an overshoot drive on a TFT LCD at 2× rate.

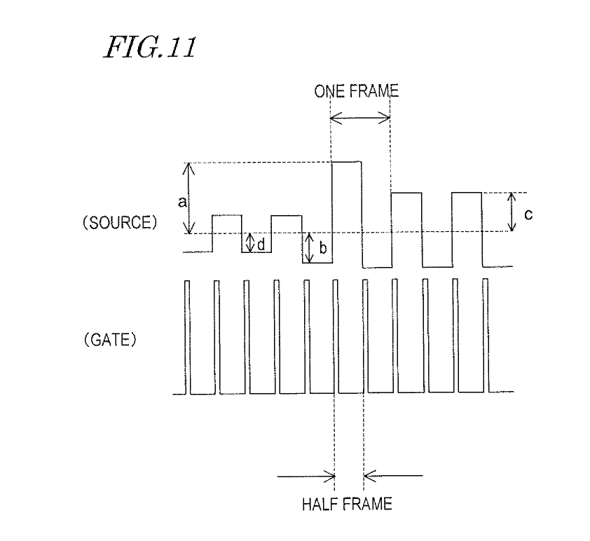

FIG. 11 shows the waveforms of a source voltage (or signal voltage) and a gate voltage (or scan voltage). In this example, the video signal has one frame period of 16.7 ms. The gate voltage goes high in a half of one frame period of 16.7 ms (i.e., in 8.4 ms) to turn a TFT ON (which is a 2× drive). When the TFT is turned ON, the source voltage is applied to the pixel. In the following example, transition is supposed to be made from the black display state (with a relative transmittance of 0%) into 168 gray scales/255 gray scales (with a relative transmittance of 40%). In the black display state, the gray scale voltage has an amplitude d of 0.5 V and the gray scale voltage associated with the 168 gray scales has an amplitude c of 2.8 V.

The waveform parameters (i.e., amplitudes a, b and c) of the source voltage shown in FIG. 11 are summarized in the following Table 2 for a conventional LCD and the LCD of the present invention:

TABLE 2

| | conventional | | | | | invention | | | | |
|---|---|---|---|---|---|---|---|---|---|---|
| | No OS | OS-A | OS-B | OS-C | OS-D | No OS | OS-A′ | OS-B′ | OS-C′ | OS-D′ |
| a | 2.8 | 4.8 | 5.0 | 5.2 | 5.4 | 2.8 | 3.4 | 3.6 | 3.65 | 3.7 |
| b | 0.5 | 0.5 | 0.5 | 0.5 | 0.5 | 2.24 | 2.24 | 2.24 | 2.24 | 2.24 |
| c | 2.8 | 2.8 | 2.8 | 2.8 | 2.8 | 2.8 | 2.8 | 2.8 | 2.8 | 2.8 |

As shown in Table 2, in the conventional drive method, transition is made from the black display state (where d=b=0.5 V) into the 168 gray scale display state (2.8 V) (i.e., a=c=2.8 V) without the OS drive. If the OS drive is adopted, the amplitude a of the source voltage is increased in the first half of one frame in which display is supposed to be conducted in 168 gray scales and an OS voltage higher than 2.8 V is applied. The OS voltages are identified by OS-A, OS-B, OS-C and OS-D in the ascending order.

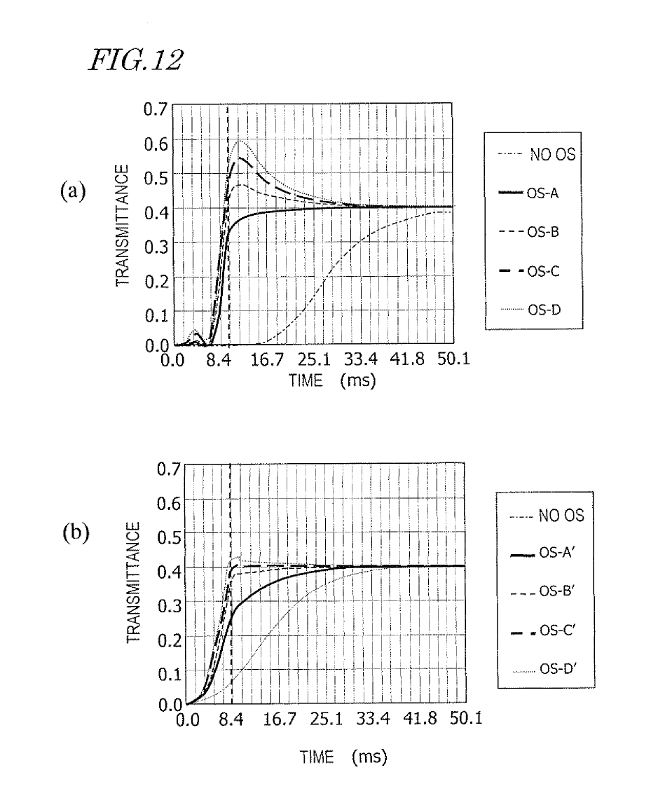

FIG. 12(a) shows how the transmittance changes with time in a situation where the source voltages shown in Table 2 are applied in the RTN mode.

As can be seen from FIG. 12(a), unless the OS drive is performed, the gray scale voltage to display 168 gray scales is 2.8 V, which is less than 2.2 times as high as the threshold voltage Vth (of 2.24 V), and therefore, no abnormal response occurs. Also, as the OS voltage OS-A is 4.8 V, which is slightly less than 2.2 times as high as the threshold voltage Vth, no abnormal response occurs, either. Under the OS-A conditions, however, the predetermined transmittance of the 168 gray scales is still not reached even in one frame period (of 16.7 ms) and the effects of the OS drive are not achieved fully. If the OS voltage becomes 2.2 or more times as high as the threshold voltage Vth (of 2.24 V), the abnormal response arises as identified by OS-B, OS-C and OS-D.

Besides, the transmittance becomes so high as to exceed the predetermined value of 168 gray scales and is still higher than the predetermined one even in one frame period (of 16.7 ms).

On the other hand, by adopting the drive method of the present invention as shown in Table 2, the predetermined transmittance of 168 gray scales can be reached in half a frame period (of 8.4 ms) and can be maintained after that as shown in FIG. 12(b).

In this preferred embodiment of a drive method according to the present invention, in the vertical scanning period (which is a half frame period in this example) just before the modes of display are changed to display 168 gray scales, the source voltage is supposed to have an amplitude b of 2.24 V (=Vth). If the OS drive is adopted, the OS voltage is supposed to have different amplitude a from the conventional one.

Take a look at the curve representing the result obtained with no OS drive shown in FIG. 12(b), and it can be seen that the response characteristic was improved compared to the result obtained with no OS drive shown in FIG. 12(a). Also, according to the curve OS-B′ associated with an amplitude a of 3.6 V, the predetermined transmittance of 168 gray scales was reached in half a frame period (of 8.4 ms) and maintained after that. As can be seen, the response characteristic, which has not been achieved by any conventional drive method even with an OS voltage that is 2.2 or more times as high as the threshold voltage Vth applied, is realized by the present invention with a lower OS voltage than the conventional one applied. That is to say, the response characteristic can be improved significantly by the present invention.

As described above, the curve OS-B′ has an OS voltage of 3.6 V, which is not more than 2.2 times as high as the threshold voltage Vth, and therefore, the abnormal response unique to the RTN mode does not manifest itself. But still the effect of increasing the response speed can be achieved. As can be seen from the foregoing description, even if the OS voltage is 2.2 or more times as high as the threshold voltage Vth, naturally it is possible to avoid the occurrence of abnormal response and to increase the response speed by applying the present invention.

According to the present invention, the response characteristic of an RTN-mode LCD can be improved. If a multi-domain structure is applied thereto, the RTN-mode LCD has a narrower distribution of response speeds, or achieves higher display luminance, than the conventional VA-mode LCD, and is advantageous than the conventional VA-mode LCD. And by applying the present invention to that multi-domain structure, a display operation of higher quality can be conducted.

Meanwhile, a so-called “pixel division” technique was proposed as a method for improving the viewing angle dependence of the γ characteristic (i.e., gray scale display characteristic) of a VA-mode LCD. The “pixel division” refers to a method in which a luminance that has been displayed by a single pixel in the prior art is displayed by two or more subpixels that are spatially separated from each other. The two or more subpixels include at least one bright subpixel that has higher luminance than the luminance to display and at least one dark subpixel that has lower luminance than the luminance to display. If the present invention is applied to such a pixel division technique, at least one subpixel needs to be driven as described above. Naturally, to maximize the effect of the present invention, the drive method described above is preferably applied to all of those subpixels. As the pixel division techniques, any of those disclosed in Japanese Patent Application Laid-Open Publications Nos. 2004-62146, 2004-78157 and 2005-189804 could be used effectively.

The entire contents of Japanese Patent Application No. 2005-281743, on which the present application claims priority, and those of Japanese Patent Application No. 2005-141846, Patent Documents Nos. 1 to 4 and Japanese Patent Application Laid-Open Publications Nos. 2004-62146, 2004-78157 and 2005-189804 mentioned above are all hereby incorporated by reference.

### INDUSTRIAL APPLICABILITY

A liquid crystal display device according to the present invention can be used effectively in a TV receiver or any other device that should have improved display quality.

1. A liquid crystal display device comprising:
a liquid crystal panel including: a vertical alignment liquid crystal layer having a liquid crystal material with negative dielectric anisotropy; first and second substrates that face each other with the liquid crystal layer interposed between them; a first electrode arranged on one surface of the first substrate so as to face the liquid crystal layer; a second electrode arranged on one surface of the second substrate so as to face the liquid crystal layer; a first alignment film arranged on one surface of the first electrode so as to face the liquid crystal layer; and a second alignment film arranged on one surface of the second electrode so as to face the liquid crystal layer, wherein a pixel has a first liquid crystal domain where first and second pretilt directions of liquid crystal molecules, defined by the first and second alignment films, respectively, intersect with each other at substantially right angles and where when a signal voltage is applied to the liquid crystal layer to display the highest gray scale, liquid crystal molecules, located around the center of a plane of the liquid crystal layer and around the middle of the thickness of the liquid crystal layer, are tilted in a first direction that substantially equally divides the first and second pretilt directions into two; and
a driver for applying a signal voltage to the liquid crystal layer of the pixel every vertical scanning period, wherein at least while display gray scales are changing from the lowest gray scale into the highest one, the driver applies a voltage that is at least 0.96 times as high as the threshold voltage Vth of the liquid crystal layer in a vertical scanning period just before the signal voltage is applied to display the highest gray scale.

2. The liquid crystal display device of claim 1, wherein a signal voltage to display the lowest gray scale is less than 0.96 times as high as the threshold voltage Vth.

3. The liquid crystal display device of claim 1, wherein while display gray scales are changing from the lowest gray scale into one for applying a signal voltage that is 2.2 or more times as high as the threshold voltage Vth, the driver applies a voltage that is at least 0.96 times as high as the threshold voltage Vth of the liquid crystal layer in a vertical scanning period just before the signal voltage is applied.

4. The liquid crystal display device of claim 1, wherein every time display gray scales change from the lowest gray scale into another one, a voltage that is at least 0.96 times as high as the threshold voltage Vth of the liquid crystal layer is applied in a vertical scanning period just before the signal voltage is applied.

5. The liquid crystal display device of claim 1, wherein the driver is able to apply an overshoot voltage as the signal voltage.

6. The liquid crystal display device of claim 1, wherein the pixel further has second, third and fourth liquid crystal domains where when a signal voltage is applied to the liquid crystal layer to display the highest gray scale, liquid crystal molecules, located around the center of a plane of the liquid crystal layer and around the middle of the thickness of the liquid crystal layer, are tilted in second, third and fourth directions, respectively, and
wherein the first, second, third and fourth directions are four directions, any two of which have a difference that is substantially equal to an integral multiple of 90 degrees.

7. The liquid crystal display device of claim 1, wherein the pixel has a number of subpixels, of which the respective liquid crystal layers are supplied with mutually different signal voltages, and
wherein at least while display gray scales are changing from the lowest gray scale into the highest one, the driver applies a voltage, which is at least 0.96 times as high as the threshold voltage Vth of the liquid crystal layer, to the liquid crystal layer of at least one of those subpixels in a vertical scanning period just before the signal voltage is applied to display the highest gray scale.
